(19) United States
(12) Patent Application Publication
(10) Pub. No.: US 2009/0161839 A1
(43) Pub. Date: Jun. 25, 2009

(54) SYSTEM AND METHOD FOR MARKETING AND PROVIDING GREETINGS

(76) Inventor: Robert L. Neumann, Pleasant Grove, UT (US)

Correspondence Address: Workman Nydegger;1000 Eagle Gate Tower, 60 East South Temple, Salt Lake City, UT, 84111, US

(21) Appl. No.: 12/340,128

(22) Filed: Dec. 19, 2008

Related U.S. Application Data
(60) Provisional application No. 61/008,963, filed on Dec. 20, 2007.

(51) Int. Cl. H04M 11/00

(52) U.S. Cl. 379/88.18

(57) ABSTRACT

Systems, methods, and apparatuses for sending audio greetings and messages to third parties. For example, a unique access code can be provided to a sender. In addition, a communication can be received from the sender. In particular, the communication can include the selection or generation of audio content to include in an audio greeting. The audio greeting can be associated with the access code. The audio content can also be delivered to a recipient.

### CROSS-REFERENCE TO RELATED APPLICATIONS

This application claims the benefit of and priority to U.S. Provisional Patent Application Ser. No. 61/008,963, filed Dec. 20, 2007, entitled “System and Method for Marketing and Providing Greetings,” the entire contents of which are incorporated herein by reference.

### BACKGROUND OF THE INVENTION

1. The Field of the Invention

The present disclosure relates generally to communications systems. In particular, the present disclosure relates to sending audio greetings.

2. The Relevant Technology

The production and sales of greeting cards make up a billion-dollar industry facilitating the exchange of pre-printed and written messages that express some sentiment to the recipient. In particular, Americans exchange approximately seven billion greeting cards every year. Greeting cards can include illustrated paper cards containing expressions of friendship, congratulations, love, condolences, or other emotions. These greeting cards can be delivered through mail services, other courier services, or can be personally delivered by the sender. Although more common in relation to special occasions, such as birthdays or holidays, greeting cards can be sent at any time to convey any message.

Greeting cards may also be used to accompany gifts. For example, a sender of a gift can include a greeting card to convey a message to the recipient. In particular, when a sender purchases a gift to be delivered to a recipient, the sender can include a message on a card to accompany the gift. The message can be pre-printed or written by the sender. If the sender is purchasing the gift over the phone, the sender can relate the message to a person taking the order, who can then type the message into a computer system—to be printed on a card—or can write the message on a card. The message can then be included with the purchased product at the time of delivery. Similarly, if a sender orders a gift on-line, the sender can type a message to be printed on a card to be included with the gift.

However, greetings cards may have limitations and/or drawbacks. For example, the use of a card to deliver a message can be impersonal, especially when the text on the card is printed or written by a person other than the sender. In addition, in some situations, it may not be possible to send a private and personal message using greeting cards. Furthermore, the use of greeting cards may be limited to pre-printed and written textual messages.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out herein.

### BRIEF SUMMARY OF THE INVENTION

The present disclosure includes methods, systems, and apparatuses for sending audio greetings. In one example embodiment, a method in accordance with the present disclosure can include providing a unique access code to a sender. In addition, the method can include receiving a communication from the sender. In particular, the communication can include the selection or generation of audio content to be sent to a recipient. The audio content can then be associated with the access code. Thereafter, the audio content can be delivered to the recipient. As a result, a sender can send a personalized audio message to a recipient rather than being restricted to often impersonal written messages associated with greeting cards or other gifts.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example method for sending an audio greeting in accordance with an implementation of the present disclosure;

FIG. 2 illustrates an additional example method for sending an audio greeting in accordance with an implementation of the present disclosure;

FIG. 3 illustrates a further example method for sending an audio greeting in accordance with an implementation of the present disclosure;

FIG. 4 illustrates a yet further example method for sending an audio greeting in accordance with an implementation of the present disclosure;

FIG. 5 illustrates an example website interface in accordance with an implementation of the present disclosure;

FIG. 6 illustrates an example embodiment of a retail card in accordance with an implementation of the present disclosure;

FIG. 7A illustrates an example embodiment of a retail sticker in accordance with an implementation of the present disclosure;

FIG. 7B illustrates an example method for marketing an audio greeting using an e-commerce website; and

FIG. 8 illustrates an example automated audio greeting system in accordance with an implementation of the present disclosure.

### DETAILED DESCRIPTION OF THE PREFERRED EMBODIMENTS

The present disclosure includes methods, systems, and apparatuses for sending audio greetings. In one example embodiment, a method in accordance with the present disclosure can include providing a unique access code to a sender. In addition, the method can include receiving a communication from the sender. In particular, the communication can include the selection or generation of audio content to create an audio greeting. The audio content can then be associated with the access code. Thereafter, the audio content can be delivered to the recipient. As a result, a sender can send a personalized audio message to a recipient rather than being restricted to often impersonal written messages that can accompany greeting cards or other gifts.

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

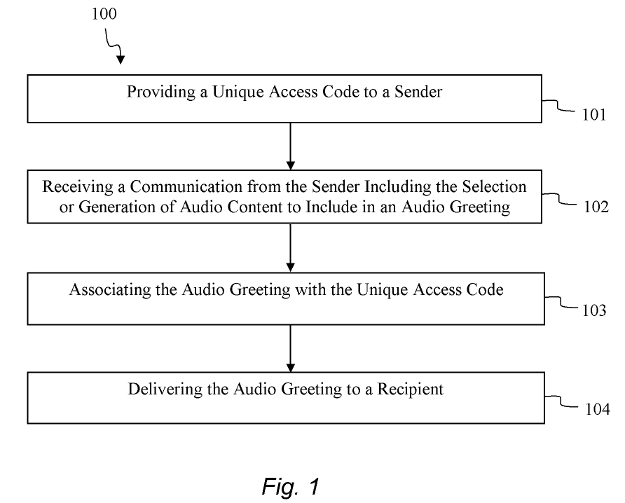

In particular, FIG. 1 illustrates an example method 100 of sending an audio greeting as can be broadly summarized as follows: First, a unique access code can be provided to a sender 101; a communication can be received from the sender including the selection or generation of audio content to be included in an audio greeting 102; the audio greeting can be associated with the access code 103; and the audio greeting can be delivered to a recipient 104.

As introduced, the example method 100 illustrated in FIG. 1 can include providing a unique access code to a sender 101. The unique access code can include a series of letters, numbers, or other symbols that is unique to a particular situation. For example, the access code can be used to uniquely identify a message to be sent by the sender to a recipient. In particular, the access code can be used to uniquely identify an audio greeting to be sent to a recipient.

The access code can be provided to the sender in any of a number of ways. In one example embodiment, the access code can be provided to the sender in conjunction with the purchase and delivery of a gift, such as flowers. For example, the sender can be provided with an access code at the time of purchase of the gift in order to send an audio greeting to the recipient of the gift.

In one example embodiment, a customer service representative—whether interacting with a sender in person, over the phone, or over the internet, such as via live chat or otherwise—can ask a sender purchasing a gift whether she would also like to send a personalized audio greeting to the recipient of the gift. If the sender answers in the affirmative, the customer service representative can provide the sender with an access code and instructions for creating and sending the audio greeting.

In a further embodiment, the access code can be provided to the sender as part of a retail product available where gifts are sold. The retail product can include a sender portion, such as a card, that includes the access code and instructions for creating and sending the audio greeting. The retail product may also include a recipient portion, such as a card, that can accompany the gift to the recipient. The recipient portion can also include an access code as well as instructions for accessing the audio greeting.

The access code may allow the sender to create and send a unique audio greeting to a recipient. For example, in one embodiment, the sender can use the access code to access an automated audio greeting system through a telephone or computer network. The audio greeting system can be configured to assist the sender to create and send an audio greeting to the recipient. In particular, the audio greeting system can include audio content selected or generated by the sender in an audio greeting and then deliver the audio greeting to the recipient.

In one example embodiment, the audio greeting system is accessible using a telephone system. In particular, the audio greeting system can be configured to automatically answer inbound telephone calls. Upon answering an inbound call from a sender, the audio greeting system can prompt the sender for the entry of an access code. The sender may then enter the unique access code using a touch-tone telephone keypad, for example, or, alternatively, the audio greeting system can be configured to automatically recognize speech and the sender can say the access code when prompted. After verifying the access code, the audio greeting system can assist the sender in creating and sending an audio greeting.

In a further embodiment, a sender can access the audio greeting system using a computer and a computer network, such as the internet. For example, the sender can use the internet to access a website linked to the audio greeting system. When prompted, the sender can input the access code into the appropriate field using a keyboard. Once the access code is verified, the sender can then use the website to create and send an audio greeting to the recipient, such as by using a microphone associated with the computer.

The example method 100 illustrated in FIG. 1 can also include the step of receiving a communication from the sender including the selection or generation of audio content to include in an audio greeting 102. In one embodiment, an audio greeting system accessed by the sender using the access code can assist the sender to select and/or generate audio content to include in an audio greeting to be delivered to the recipient.

For example, the sender may use the audio greeting system to select pre-recorded audio content to include in the audio greeting. The pre-recorded audio content can include, but is not limited to, any of the following: audio greetings produced in-house using voice talent, scripts and sound effects; sound effects without voice talent/script (e.g., mechanical sounds, nature sounds, ambient sounds, etc.); licensed content owned and produced by others (e.g., voices of Disney characters, celebrity voices, movie lines, jokes from comedians, etc.); music; other similar audio content, and/or combinations of the same.

The pre-recorded audio content can be specifically tailored for any occasion. For example, portions of pre-recorded audio content can relate to birthdays, holidays, anniversaries, deaths, graduations, weddings, illnesses, births, and/or any other event or occasion. In addition, the pre-recorded audio content can include expressions of gratitude, congratulations, sympathy, humor, concern, inspiration, love, forgiving, friendship, good luck, farewell, or other similar sentiments.

In one embodiment of the present disclosure, after accessing an audio greeting system using a telephone, the sender can be presented with a series of prompts in order to select pre-recorded audio content to include in an audio greeting. In particular, the audio greeting system can present a menu of pre-recorded audio content to the sender. The pre-recorded audio content can be separated into specific categories such as “humor”, “birthdays”, “romance”, and the like. The sender can preview the pre-recorded content by listening to portions of pre-recorded audio content. The sender can then select one or more portions of pre-recorded audio content to include in an audio greeting.

In a further embodiment, after accessing an audio greeting system over the internet, the sender can be presented with a plurality of links to portions of pre-recorded audio content. The sender can preview the pre-recorded audio content by clicking on the corresponding links. After previewing the pre-recorded audio content, the sender can select one or more portions of pre-recorded audio content to include in an audio greeting.

In a yet further embodiment, both a telephone and an internet system can be used to select the pre-recorded audio content. For example, a sender can preview portions of pre-recorded audio content using the internet as explained above. In addition, each portion of pre-recorded audio content can be associated with an identifying number. The sender can select a portion of pre-recorded audio content and take note of the corresponding identifying number. The sender can then call into an audio greeting system as also explained above. When prompted, the sender can enter the identifying number to designate the pre-recorded audio content to be included in an audio greeting. Of course, one will appreciate that there are additional ways to receive a communication from a sender including the selection of pre-recorded audio content.

In addition to, or in the alternative of, selecting one or more portions of pre-recorded audio content, the sender can generate audio content by recording a message to include in the audio greeting. In one example embodiment, an audio greeting system can inquire whether a sender wants to generate audio content to include in the audio greeting. If the sender answers affirmatively, the audio greeting system can record audio content generated by the sender. In particular, the audio greeting system can record a voice message from the sender. In additional embodiments, the sender can sing, play musical instruments, read a message, and/or perform other acts to generate audio content to include in the audio greeting.

In one embodiment, the sender may use the audio greeting to convey an invitation to the recipient. For example, the sender may configure an audio greeting to include details and directions regarding an engagement to which the recipient is invited. The sender may then set up the audio greeting to be delivered to a plurality of recipients including each person to be invited.

In a further embodiment, the audio greeting system can convert written text into audio content. For example, a sender may wish to send audio content including a voice message, but may not wish, or may not be able, to record her own voice. Accordingly, the sender can input a portion of text to the audio greeting system and the audio greeting system can use text-to-speech software to convert the text into audio content to include in an audio greeting. The sender may also choose what type of voice to use for the generated audio content.

Similarly, a sender may wish to alter the sound of her own voice for the audio greeting. Accordingly, the audio greeting system can be configured to modify the generated audio content in order to alter the sound of the sender's voice. For example, the audio greeting system can alter the sender's voice to sound higher, lower, faster, slower, and/or can perform other similar voice alterations.

The audio greeting system may also combine pre-recorded audio content as a background to audio content generated by the sender. For example, the audio greeting system can add music, ambient sounds, and/or other sound effects as a background to audio content recorded from the sender.

In addition to audio content, an audio greeting system in accordance with the present disclosure can be configured to include other multi-media content, such as video and photographs. For example, in one embodiment, a sender can use a webcam, handheld camera, or other device to generate video content. The audio greeting system can be configured to receive this video content generated by the sender and include it in an audio greeting to be sent to a recipient.

The example method 100 illustrated if FIG. 1 can also include the step of associating the audio greeting created by the sender with the unique access code 103. For example, the access code can uniquely identify an audio greeting created by the sender. In one embodiment, within an audio greeting system, an audio greeting can be linked to the access code such that it can only be accessed using the access code. In addition, the audio greeting can be created and associated with the access code before the access code is provided to the sender. For example, the access code can be provided to the sender once the process of creating the audio greeting is complete rather than prior to creating the audio greeting. The sender may then use the access code to retrieve the audio greeting at a later time or to deliver the audio greeting to the recipient.

The example method 100 of FIG. 1 can further include the step of delivering the audio greeting to a recipient 104. In one example embodiment, an audio greeting system can provide an option to send the audio greeting to a particular destination, such as a phone number, e-mail address, instant messaging address, or similar contact information. The sender can input a destination corresponding to the recipient. The audio greeting system can then automatically deliver the audio greeting to the recipient. One will also appreciate, that the sender can designate a plurality of destinations in order to send a single audio greeting to a plurality of recipients.

In one embodiment, the audio greeting can be delivered as soon as it is created. In further embodiments, delivery of the audio greeting can be delayed until a predetermined date and time chosen by the sender. For example, a sender may set up the audio greeting to be delivered on a particular day, such as the recipient's birthday.

Delivering the audio greeting can include sending the actual audio greeting to the recipient through a phone call, e-mail, text message, instant message, SMS, EMS, MMS, and/or other similar delivery channels. In a further embodiment, delivering the audio greeting can include sending the recipient the unique access code and instructions for accessing the audio greeting using an automated audio greeting system. For example, the recipient may access the audio greeting system using a telephone. In a yet further embodiment, the recipient may access the audio greeting system by accessing a website using the access code and then downloading the corresponding audio greeting.

In one embodiment, the audio greeting can be delivered with flowers, gifts, gift cards, greeting cards, or any other item. In particular, a card, or other item, including the unique access code can be delivered along with a gift to the recipient. The card can include instructions on how to use the access code to access an audio greeting. The recipient can access an automated audio greeting system to receive the audio greeting stored therein. In one embodiment, the recipient can call into the audio greeting system and enter the access code when prompted. Thereafter, the audio greeting system can play the audio greeting for the recipient.

In a further embodiment, a customer service representative handling the purchase of a gift to be sent to a recipient, can type or write the necessary information for retrieving the audio greeting onto a card or into a computer system to be later printed on the card to be delivered with the gift. In particular, the card can include the unique access code associated with the audio greeting as well as instructions for accessing the audio greeting. Upon delivery of the gift, the recipient can use the access code to retrieve the audio greeting.

In an additional embodiment, the audio greeting system can automatically call the recipient to deliver or inform the recipient of the audio greeting. If the recipient receives the audio greeting directly on her phone, the greeting can either play automatically or play in response to a prompt from the recipient. If the recipient is not available to answer the phone call, the audio greeting can be delivered as a voice mail message so that it can be listened to at a later time. In addition, if initial attempts to deliver the audio greeting are unsuccessful, the audio greeting system can be configured to make multiple delivery attempts until delivery is successful.

In a yet further embodiment, the audio greeting can be sent as an attachment to an electronic communication. For example, the audio greeting can be electronically attached to a text message, instant message, e-mail, or the like. The recipient can then use a computer or handheld communication device to retrieve and listen to the audio greeting.

One will appreciate that one or more of the steps of the method 100 disclosed in FIG. 1 can be automatically completed using an automated audio greeting system. For example, the audio greeting system may automatically perform one or more acts in accordance with information received from a sender, to create and deliver an audio greeting. Additionally, one or more of the steps associated with the method 100 can be performed automatically and/or in real time by an e-commerce website, whether independent of or in conjunction with the audio greeting system.

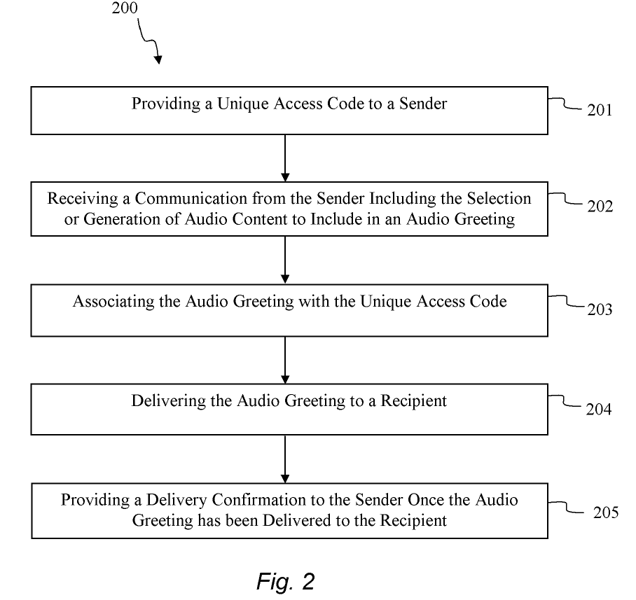

FIG. 2 illustrates an additional example method 200 for sending an audio greeting in accordance with an implementation of the present disclosure. In particular, the method 200 for sending an audio greeting can include providing a unique access code to a sender 201; receiving a communication from the sender including the selection or generation of audio content to include in an audio greeting 202; associating the audio greeting with the unique access code 203; delivering the audio greeting to a recipient 204; and providing a delivery confirmation to the sender once the audio greeting has been delivered to the recipient 205.

The example method 200 of FIG. 2 may be similar to the method 100 previously described above and shown in FIG. 1 in most respects, wherein certain steps will not be described in relation to this configuration wherein those steps may be completed in the manner as described above and are hereby incorporated into this additional configuration.

Specifically, method 200 includes the additional step of providing a delivery confirmation to the sender once the audio greeting has been delivered to the recipient 205. For example, once the recipient receives or accesses the audio greeting, an audio greeting system can automatically send a confirmation to the sender to inform the sender of the delivery. In one embodiment, the sender may choose in advance of delivering the audio greeting whether she would like to receive a delivery confirmation as well as the method of sending the delivery confirmation. For example, the delivery confirmation can include an automated telephone call, an e-mail, a text message, an instant message, or other similar communication. Accordingly, the sender can be automatically informed of the delivery of the audio greeting without needing to contact the recipient directly.

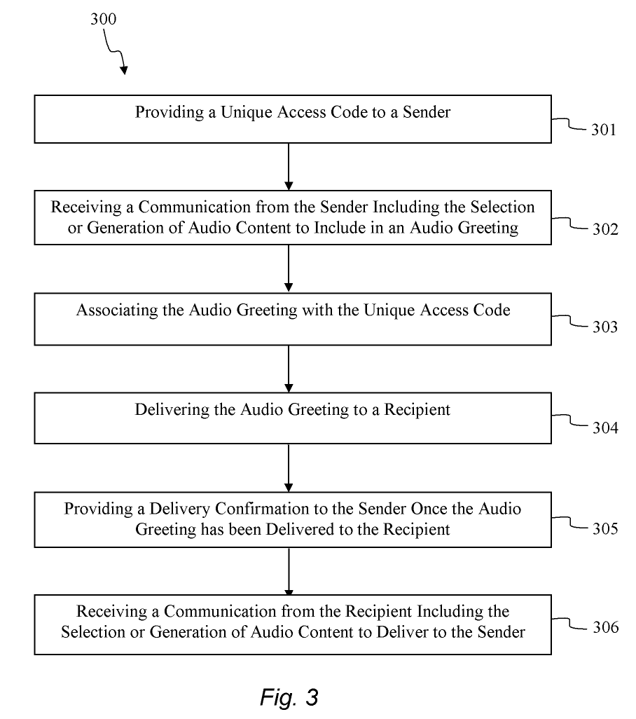

FIG. 3 illustrates a further example method 300 for sending an audio greeting in accordance with an implementation of the present disclosure. In particular, the method 300 for sending an audio greeting can include providing a unique access code to a sender 301; receiving a communication from the sender including the selection or generation of audio content to include in an audio greeting 302; associating the audio greeting with the unique access code 303; delivering the audio greeting to a recipient 304; providing a delivery confirmation to the sender once the audio greeting has been delivered to the recipient 305; and receiving a communication from the recipient including the selection or generation of audio content to deliver to the sender 306.

The example method 300 of FIG. 3 may be similar to the methods 100, 200 previously described above and shown in FIGS. 1 and 2 in most respects, wherein certain steps will not be described in relation to this configuration wherein those steps may be completed in the manner as described above and are hereby incorporated into this additional configuration.

Specifically, method 300 includes the additional step of receiving a communication from the recipient including the selection or generation of audio content to deliver to the sender 306. Accordingly, the recipient of an audio greeting may be given the option to select or generate audio content to be included in an audio greeting to reply to the audio greeting sent by the sender.

For example, after delivering the sender's audio greeting, the audio greeting system may provide the recipient the option to send a reply audio greeting to the sender. If the recipient responds in the affirmative, the audio greeting system can provide the recipient with a menu of pre-recorded audio content and can record additional audio content generated by the recipient. The audio greeting system can then include the selected and/or generated audio content into a reply audio greeting and deliver the audio greeting to the sender. In particular, the reply can comprise an automated telephone call, an e-mail, a text message, an instant message, similar communication means, and/or combinations of the same. In one example embodiment, the reply audio greeting can include a response from the recipient to an invitation extended in the original audio greeting sent by the sender.

In an additional embodiment, the recipient may be able to forward the audio greeting to additional recipients and/or communications devices. For example, the recipient can forward the audio greeting from a cell phone to a home phone, from a cell phone to a computer, from a home phone to a cell phone, from a computer to a cell or home phone, from a handheld device to a cell or home phone or a computer, or between any other devices configured to send or receive a telephone call, e-mail, text message, instant message, or other communication.

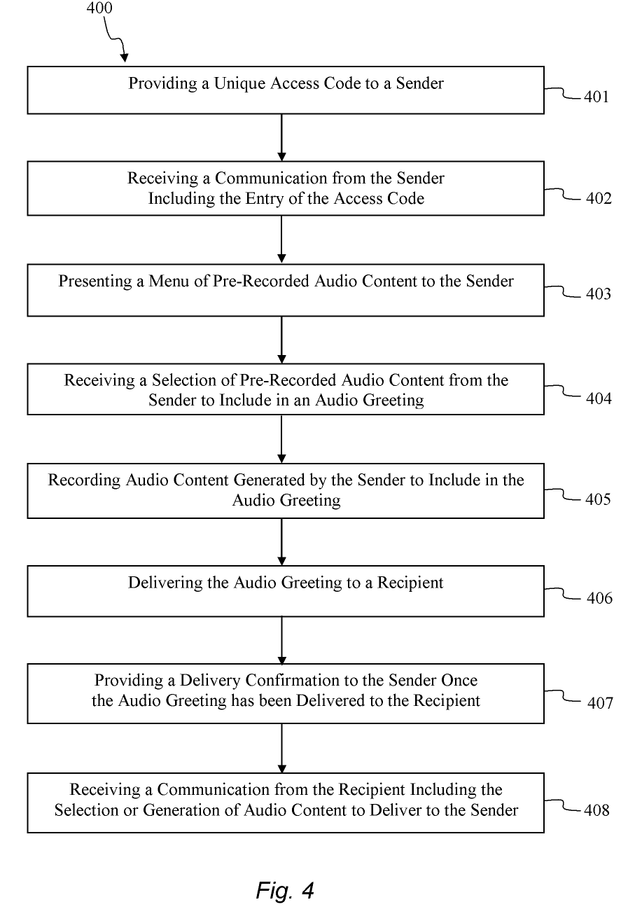

FIG. 4 illustrates a yet further example method for sending an audio greeting in accordance with an implementation of the present disclosure. The example method 400 of FIG. 4 may be similar to the methods 100, 200, 300 previously described above and shown in FIGS. 1-3 in most respects, wherein certain steps will not be described in relation to this configuration wherein those steps may be completed in the manner as described above and are hereby incorporated into this additional configuration.

In particular, the method 400 for sending an audio greeting can include providing a unique access code to a sender 401. For example, a unique series of numbers, letters, or other symbols can be provided to the sender. The access code can be unique to that particular sender.

Thereafter, the method 400 can include receiving a communication from the sender including the entry of the access code 402. In one embodiment, the sender can call a phone number that directs the sender's phone call to an automated audio greeting system. In order to gain access to the audio greeting system, the sender can enter the unique access code when prompted. The audio greeting system can then present a menu of pre-recorded audio content to the sender 403. The pre-recorded audio content can include portions of audio content suitable for a variety of different occasions and/or messages. The audio greeting system can then receive a selection of pre-recorded audio content from the sender to include in an audio greeting 404. In one embodiment, the sender can enter a number identifying the desired pre-recorded audio content when prompted to do so by the audio greeting system.

The audio greeting system may then record audio content generated by the sender to include in the audio greeting 405. For example, the audio greeting system can record a voice message from the sender to include with the pre-recorded audio content already selected.

The audio greeting system can then deliver the audio greeting to a recipient 406. In particular, the audio greeting system can be accessed by a recipient using the same access code provided to the sender. Alternatively, the audio greeting system can automatically send the audio greeting to the recipient's phone. Thereafter, the audio greeting system can provide a delivery confirmation to the sender once the audio greeting has been delivered to the recipient 407. In particular, the audio greeting system can send an automatic phone or electronic message to the sender informing her that the audio greeting has been successfully delivered to the recipient.

In addition, the audio greeting system can receive a communication from the recipient including the selection or generation of audio content to deliver to the sender 408. The audio greeting system can then include the audio content selected and/or generated by the recipient in a reply audio greeting to be delivered to the sender.

In a further embodiment, in addition to sending and/or receiving audio greetings, the methods described herein can include delivering advertising content to a sender and/or recipient as part of the process of creating and delivering an audio greeting. For example, an audio greeting can be accompanied by a short audio advertisement when delivered to the recipient. In particular, a recipient who accesses an audio greeting system using a telephone may be greeted with an audio advertisement from a sponsor prior to hearing the audio greeting. Similarly, during the process of creating an audio greeting, a sender may also receive advertisement content from the system. In a yet further embodiment, the advertisement content can include video, graphics, and/or text, such as may be sent via email, text message, instant message, or by other communications channels.

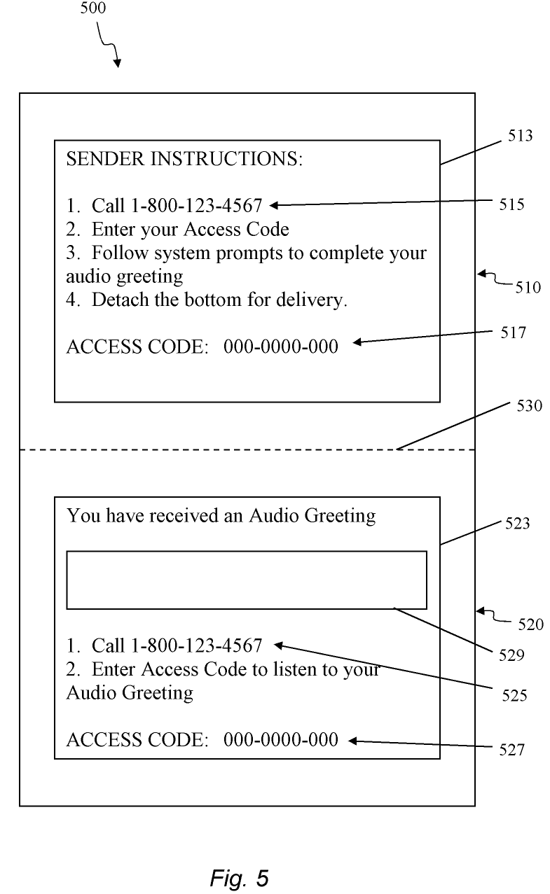

FIG. 5 illustrates an example retail card 500 that can be used to perform one or more steps of the methods 100, 200, 300, 400 illustrated in FIGS. 1-4 and disclosed in more detail above. For example, the example retail card 500 can include a sender portion 510 detachably coupled to a recipient portion 520. In particular, the sender portion 510 can be configured to assist a sender to create an audio greeting for a recipient. The sender can then deliver the recipient portion 520 to the recipient. The recipient portion 520 can be configured to assist the recipient to access the audio greeting created by the sender.

The retail card 500 can be formed using any of a number of different materials. For example, in one embodiment, the retail card 500 includes a paper product. In further embodiments, the retail card 500 can be formed using other materials, such as plastics, wood, cardboard, and/or metal. It is intended that the retail card 500 be placed in a retail outlet near greeting cards, gift cards, flowers, or other items that may be sold as gifts. A customer may decide to purchase the retail card 500 in order to send a recipient an audio greeting in addition to a greeting card, gift card, flowers or gift being purchased for the recipient.

The sender portion 510 of the retail card 500 can include sender instructions 513 printed on the face of the sender portion 510. The sender instructions 513 include a step-by-step guide for creating an audio greeting. In particular, the sender instructions 513 can include a phone number 515 that the sender can call to use an audio greeting system. The sender instructions 513 may also include a unique access code 517 that the sender can enter when prompted in order to access the audio greeting system. The sender instructions 513 can also include additional guidance to assist the sender in creating an audio greeting to be sent to a recipient.

As illustrated, the sender portion 510 can be detachably coupled to the recipient portion 520 along a perforation 530 in the retail card 500. Once the sender creates an audio greeting, the sender can detach the recipient portion 520 and deliver it to the recipient. In one embodiment, the recipient portion 520 can be inserted into an envelope (not shown) to deliver to the recipient. The sender may also include a written note for the recipient in the note box 529 of the recipient portion 520.

The recipient portion 520 can include recipient instructions 523 printed on the face of the recipient portion 520 for the retail card 500. For example, the recipient instructions 523 can include a phone number 525 that the recipient can call to use the audio greeting system. The recipient instructions 523 can also include an access code 527 that the recipient can enter when prompted in order to access the audio greeting system. The phone number 525 and access code 527 provided to the recipient may be the same or different than the phone number 515 and access code 517 provided to the sender. Once the recipient enters the access code 527, she can access the audio greeting created by the sender. In a further embodiment, the recipient may also be able to create a reply audio greeting for the sender.

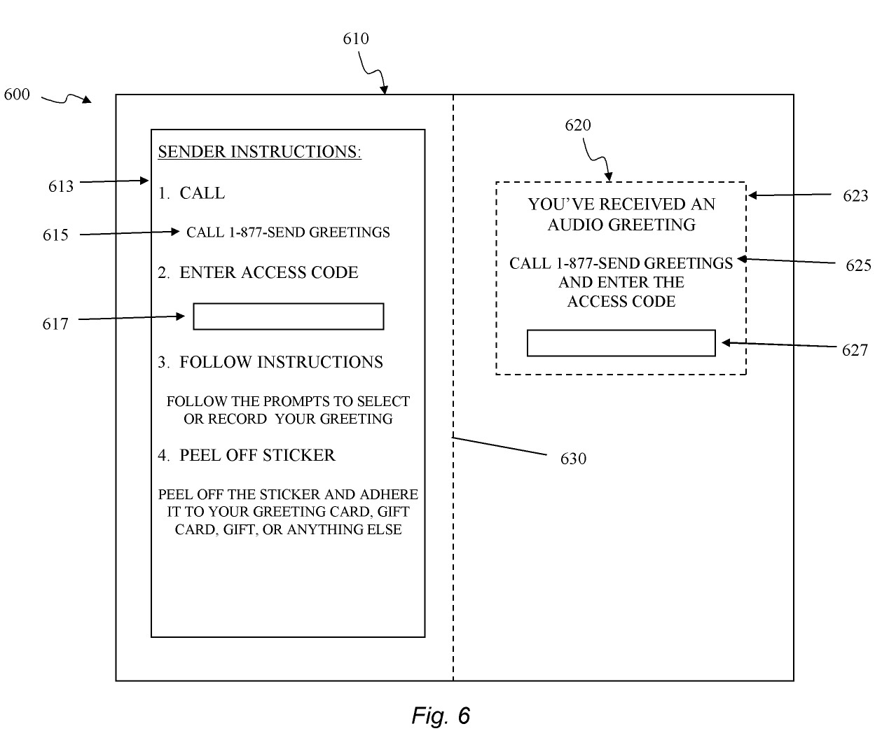

FIG. 6 illustrates an additional example retail card 600 that can be used to perform one or more steps of the methods 100, 200, 300, 400 illustrated in FIGS. 1-4 and disclosed in more detail above. In addition, the example retail card 600 of this configuration may be functionally similar to the example retail card 500 previously described above and shown in FIG. 5 in most respects, wherein certain features will not be described in relation to this configuration wherein those components may function in the manner as described above and are hereby incorporated into this additional configuration described below. Like structures and/or components are given like reference numerals.

The example retail card 600 can include a sender portion 610 detachably coupled to a recipient portion 620. In particular, the sender portion 610 can be configured to assist a sender to create an audio greeting for a recipient. The sender can then deliver the recipient portion 620 to the recipient. The recipient portion 620 can be configured to assist the recipient to access the audio greeting created by the sender. In the current embodiment, the sender portion 610 comprises a bi-fold card while the recipient portion 620 comprises a sticker. As used herein, the term “sticker” includes any adhesive-backed device, such as stickers, decals, adhesive labels, adhesive tags, and/or other similar devices, regardless of the materials used to manufacture the device.

The sender portion 610 of the retail card 600 can be folded along a crease 630 and can contain sender instructions 613 as well as the recipient portion. Alternatively, the sender portion 610 can comprise a flat unfolded card. The sender instructions 613 can be printed on the sender portion 610 and can guide the sender through specific steps to create an audio greeting. In particular, the sender instructions 613 can include a phone number 615 that the sender can call to use an audio greeting system. The sender instructions 613 may also include a unique access code 617 that the sender can enter when prompted in order to access the audio greeting system. The access code 617 can be added to the retail card 600 prior to or at the time of purchase by the sender. The sender instructions 613 can also include additional guidance to assist the sender in creating an audio greeting to be sent to a recipient.

As illustrated, the sender portion 620 can be detachably adhered inside the sender portion 610 in the retail card 600. Once the sender creates an audio greeting, the sender can detach the recipient portion 620 and adhere it, using the recipient portion's 620 adhesive backing, to any item being delivered to the recipient. For example, the recipient portion 620 can be adhered within a greeting card, to a gift card, to flowers, to an insert card, to a gift, or any other item being delivered to the recipient.

The recipient portion 620 can include recipient instructions 623. For example, the recipient instructions 623 can include a phone number 625 that the recipient can call to use the audio greeting system. The recipient instructions 623 can also include an access code 627 that the recipient can enter when prompted in order to access the audio greeting system. The phone number 625 and access code 627 provided to the recipient may be the same or different than the phone number 615 and access code 617 provided to the sender. Once the recipient enters the access code 627, she can access the audio greeting created by the sender.

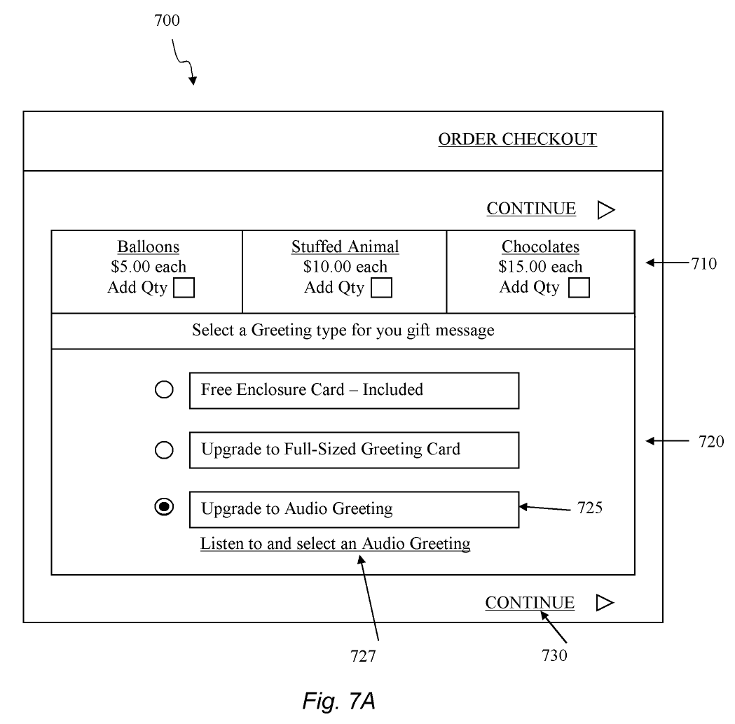

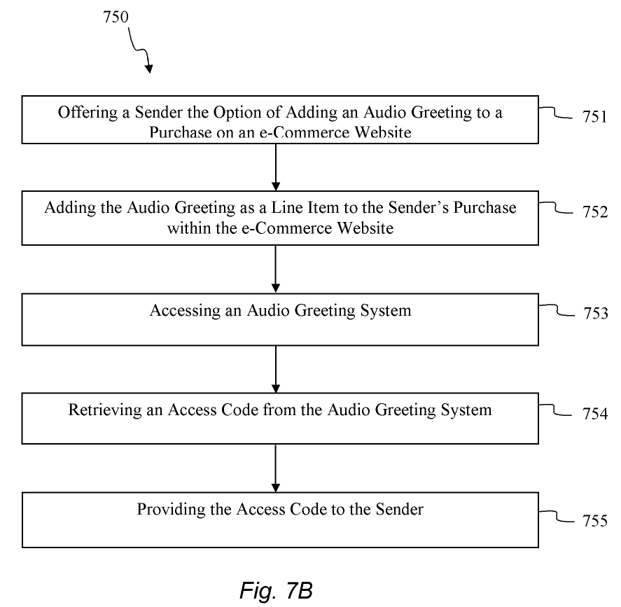

FIG. 7 illustrates an example website interface 700 in accordance with an implementation of the present disclosure. In particular, the website interface 700 of FIG. 7 illustrates a typical merchant website (such as from an online retailer or “e-tailer”) that a sender might encounter during the checkout process when purchasing a gift on-line for a recipient. The example website interface 700 and/or a corresponding server/system can be configured to perform one or more of the steps of the example methods 100, 200, 300, 400 illustrated in FIGS. 1-4 and described in more detail above, or method 700 illustrated in FIG. 7B and described in more detail below.

As illustrated, the website interface 700 includes a gift section 710 that provide a sender the option to add one or more additional gifts to the order. The website interface 700 also includes a greeting section 720, in which a sender can choose the type of greeting to accompany the gift being purchased. In particular, the sender can choose to upgrade to an audio greeting 725 using the greeting section 720 of the website interface 700. The greeting section 720 may also include an audio greeting link 727, which a sender can use to listen to and select a particular audio greeting to include with the order. Once the sender has selected which greeting to include, she can advance to the next step in the checkout process by clicking on the continue link 730.

The example website interface 700 may be one of a sequence of website interfaces used to perform the method 750 illustrated in FIG. 7B. In particular, FIG. 7B discloses an example method 750 of marketing an audio greeting.

In particular, the method 750 can include offering the sender the option of adding an audio greeting to a purchase on an e-commerce website 751. As used herein, “e-commerce website” includes any website maintained by any party offering goods or services over the internet. In particular, this step can include offering to include an audio greeting in the sender's order from the e-commerce website as part of the “checkout” process. For example, a link or drop-down menu can be provided with which the sender can include an audio greeting to the sender's order, as shown in the example website interface 700 illustrated in FIG. 7A.

The method 750 can also include adding the audio greeting as a line item to the sender's purchase within the e-commerce website 752. In particular, an e-tailer can include the audio greeting as a line item to the sender's order (or “shopping cart”) during the checkout process.

The method 750 can further include accessing an audio greeting system 753. For example, once an audio greeting is added to a sender's order, the e-tailer and/or e-commerce website can automatically access an audio greeting system in order to provide an access code to the sender. In particular, the audio greeting system can be accessed in order to obtain a unique access code to be associated with the audio greeting. Accessing the audio greeting system may include the use of a unique username and password assigned to the e-tailer or e-commerce website. For example, the e-tailer may have an account set up with the audio greeting system that is associated with the username and password, thereby providing the e-tailer access to the audio greeting system. Accessing the audio greeting system can occur automatically and in real time during the transaction with the sender. In particular, the e-commerce website can automatically send an electronic communication including the username and password to the audio greeting system during the checkout process. Furthermore, while a username and password is disclosed, any other verification device known in the art can be used to verify the e-tailer's status and thereby grant the e-tailer access to the audio greeting system.

The method 750 can further include the step of retrieving an access code from the audio greeting system 754. For example, once an e-tailer accesses the audio greeting system, the e-tailer can retrieve a unique access code from the audio greeting system which will be associated with the sender's audio greeting. In one example embodiment, the audio greeting system can automatically send a unique access code to the e-commerce website once the audio greeting system is accessed and the e-commerce website's status is verified. This can be achieved through electronic communication over the internet or other network. In a further embodiment, the access code can be provided by the audio greeting system automatically and in real time during the sender's checkout process.

Finally, the method 750 can include the step of providing the access code to the sender 755. For example, once the e-commerce website has obtained a unique access code from the audio greeting system, it can provide it to the sender along with instructions on how to set up the audio greeting. In one example embodiment, the access code can be provided to the sender in conjunction with an order confirmation. The order confirmation may be displayed to the sender as part of the checkout process or can be sent as a separate communication, such as by e-mail. The access code and set-up instructions can also be provided independent of the order confirmation, such as by an automated phone message, e-mail, text message, and/or instant message.

Accordingly, the method 750 illustrated in FIG. 7B can allow an e-commerce website to automatically obtain and provide, upon customer request, a unique access code and corresponding instructions to the customer in real time so that the customer can send an audio greeting to a recipient, so as, for example, to accompany another item (e.g., gift, gift card, greeting card, flowers) being purchased from the e-commerce website.

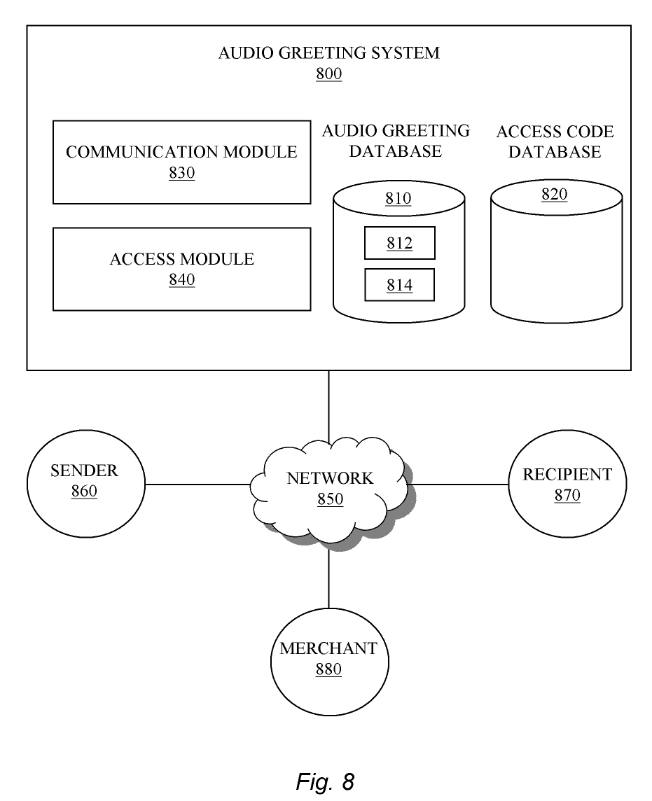

FIG. 8 illustrates an example automated audio greeting system 800 in accordance with an implementation of the present disclosure. In particular, the audio greeting system 800 can include an audio greeting database 810 configured to store audio greetings including pre-recorded audio content 812 and sender-generated audio content 814. The audio greeting system 800 may also include an access code database 820 configured to store access codes. In particular, the access code database 820 can store at least one access code for every audio greeting stored in the audio greeting database 810. In addition, each access code stored in the access code database 820 can be linked to a corresponding audio greeting stored in the audio greeting database 810.

The audio greeting system 800 may also include a communication module 830 configured to receive communications from and send communications to outside sources. In particular, the communication module 830 can be configured to send and receive telephone calls, e-mail, text messages, instant messages, and/or other similar types of electronic or physical communications. For example, the communication module 830 may be configured to answer inbound telephone calls from senders 860 creating audio greetings and/or recipients 870 receiving audio greetings. The communication module 830 may also be configured to communicate with merchant 880 in order to provide access codes to merchants for customers wishing to purchase an audio greeting in conjunction with the purchase of a gift from the merchant 880. The communication module 880 can communicate with a sender 860, recipient 870, and/or merchant 880 through a network 850. The network 850 may be any communications network, such as a telephone network, the internet, or any other similar communications network.

The audio greeting system 800 can also include an access module 840. In particular the access module 840 can be configured to verify access codes entered by senders 860 and/or recipients 870. Once the access code entered by a sender 860 or recipient 870 is verified, the access module 840 can grant the sender 860 or recipient 870 access to the audio greeting system 800. In particular, the access module 840 can grant the sender 860 access in order to create an audio greeting. Once created and stored in the audio greeting database 810, the access module 840 can then grant a recipient 870 access to the audio greeting.

The audio greeting system 800 can be configured to automatically perform one or more steps of the methods 100, 200, 300, 400 illustrated in FIGS. 1-4 and disclosed in more detail above. The audio greeting system 800 can also be configured to operate in conjunction with retail cards 500, 600 and/or website interface 700 illustrated in FIGS. 5, 6, and 7, respectively, and described in more detail above.

For example, the audio greeting system 800 may receive an inbound call from a sender 860 and automatically request the entry of a valid access code. Upon entry of a valid access code, the sender 860 may be allowed to create an audio greeting by selecting or generating audio content. The audio greeting system 800 may then store the audio greeting within its electronic storage medium, such as in the audio greeting database 810. The sender 860 may then provide the access code to the recipient 870 in conjunction with the delivery of a gift or some other item.

The audio greeting system 800 may then receive an inbound telephone call from the recipient. The recipient 870 may be automatically queried by the audio greeting system 800 to enter the access code provided from the sender using a telephone keypad. Upon entry of a valid access code, the corresponding audio greeting may be retrieved from the electronic storage medium of the audio greeting system 800 and played to the recipient.

In the event that a sender 860 makes an online purchase of a gift through from the merchant 880 and elects to leave an audio greeting for the recipient, the merchant 880 website may request from the audio greeting system 800 over the network 850, such as the internet, a valid access code. When the request for the access code is received at the audio greeting system 800, the audio greeting system 800 can automatically identify and validate the website requesting the access code and automatically generate the access code and provide it over the network 850 to the merchant 880.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for sending audio greetings comprising:
providing a unique access code to a sender;
receiving a communication from the sender, the communication including the selection or generation of audio content to include in an audio greeting;
associating the audio greeting with the access code; and
delivering the audio greeting to a recipient.

2. The method of claim 1, wherein receiving the communication from the sender further comprises receiving an inbound telephone call from the sender.

3. The method of claim 2, further comprising presenting a menu of pre-recorded audio content to the sender and allowing the sender to make a selection of pre-recorded audio content to include in the audio greeting.

4. The method of claim 3, further comprising recording audio content generated by the sender to include in the audio greeting.

5. The method of claim 4, further comprising receiving an inbound telephone call from the recipient and, in response, delivering the audio greeting to the recipient.

6. The method of claim 1, wherein delivering the audio greeting to the recipient comprises sending the audio greeting by way of telephone, e-mail, instant message, or text message.

7. The method of claim 1, further comprising automatically providing a delivery confirmation to the sender once the audio greeting has been delivered to the recipient.

8. The method of claim 1, further comprising providing the access code to the sender in conjunction with the sender's purchase of a gift for the recipient.

9. The method of claim 1, further comprising delivering a reply audio greeting from the recipient to the sender.

10. The method of claim 1, wherein providing an access code to the sender comprises providing the sender with an audio greeting kit comprising:
a sender card comprising the access code and instructions to select or generate audio content to include in the audio greeting;
a recipient card detachably coupled to the sender card along a perforation, the recipient card including the access code and instructions for accessing the audio greeting.

11. The method of claim 1, wherein providing an access code to the sender comprises providing the sender with an audio greeting kit comprising:
a sender card comprising the access code and instructions to select or generate audio content to include in the audio greeting;
a sticker detachably coupled to the sender card, the sticker including the access code and instructions for accessing the audio greeting.

12. The method of claim 1, further comprising receiving a telephone call from the recipient and wherein the access code is entered by the recipient using a touch-tone telephone.

13. The method of claim 1, wherein the audio greeting is automatically delivered to the recipient at a predetermined date and time.

14. The method of claim 1, wherein the audio greeting further comprises video content.

15. The method of claim 1, further comprising delivering advertising content to the sender or the recipient.

16. An audio greeting delivery kit comprising:
a sender portion comprising a sender access code and instructions for a sender to select or generate audio content to include in an audio greeting;
a recipient portion detachably coupled to the sender portion, the recipient portion comprising a recipient access code and instructions for accessing the audio greeting.

17. The kit of claim 16, wherein the sender portion comprises a sender card coupled along a perforation to the recipient portion comprising a recipient card, and further comprising an envelope configured to receive the recipient card.

18. The kit of claim 17, wherein the sender card comprises cardboard, paper, or plastic.

19. The kit of claim 16, wherein the sender portion comprises a card and wherein the recipient portion comprises a sticker.

20. A method of marketing audio greetings comprising:
offering a sender the option of adding an audio greeting to a purchase from an e-commerce website;
adding the audio greeting as a line time to the purchase;
accessing an audio greeting system;
retrieving a unique access code from the audio greeting system; and providing the unique access code to the sender.

21. The method of claim 20, wherein accessing the audio greeting system and retrieving the unique access code is performed automatically or in real time.
